(19) United States
(12) Patent Application Publication
(10) Pub. No.: US 2017/0101920 A1
(43) Pub. Date: Apr. 13, 2017

(54) METHOD OF DETERMINING THE TEMPERATURE OF A CYLINDER HEAD

(71) Applicant: JAGUAR LAND ROVER LIMITED, Warwickshire (UK)

(72) Inventors: Hani ALRIFAI, Whitley, Coventry, Warwickshire (UK); William HUTCHINS, Whitley, Coventry, Warwickshire (UK)

(21) Appl. No.: 15/315,421

(22) PCT Filed: May 22, 2015
(86) PCT No.: PCT/EP2015/061386

§ 371 Date: Dec. 1, 2016

(30) Foreign Application Priority Data
Jun. 2, 2014 (GB) 1409740.6

(51) Int. Cl. F01P 5/12; F01P 11/16; F02F 1/40; F01P 3/02

(52) U.S. Cl. CPC F01P 5/12; F01P 3/02; F01P 11/16; F02F 1/40; F01P 2003/024

(57) ABSTRACT

A method of determining the temperature of an inner section of a cylinder head (204) in an internal combustion engine. The engine comprises: at least one piston cylinder (201) which cylinder is formed at least in part by the cylinder head (204); and at least one jacket (205), the jacket having a proximal wall and a distal wall. The proximal wall of the jacket is proximate to the piston cylinder (201) and the distal wall of the jacket is distal to the piston cylinder (201). The method comprises: providing a temperature sensor (202) on the distal wall of the jacket; receiving a first temperature measurement from the temperature sensor (202); and inferring the temperature of the inner section of the cylinder head (204) from the first temperature measurement.

### TECHNICAL FIELD

This invention relates to a method of determining the temperature of a cylinder head in an internal combustion engine, to a method of controlling a coolant pump in an internal combustion engine, and to an engine and a vehicle incorporating means to employ these methods.

### BACKGROUND

The piston cylinder in an internal combustion engine typically generates a lot of heat when the engine is running. This is because the combustion of the fuel occurs inside the cylinder, releasing heat as well as the expanding gasses which drive the engine. Regulating this heat is important because engines typically have an ideal operating temperature. If the engine operates significantly below or above this temperature, then the engine's efficiency is reduced, and in extreme cases the engine may be damaged. For this reason internal combustion engines are typically provided with coolant, which is pumped around the engine in order to transport heat and help maintain the engine at an appropriate temperature.

FIG. 1 is a diagram of a first coolant system 101 for an internal combustion engine according to the prior art. Coolant, which is typically composed primarily of water, is pumped by a pump 102 as illustrated using arrows 103. Upon leaving the pump, the coolant is pumped to a cylinder jacket 104. The cylinder jacket 104 surrounds the piston cylinders of the engine (not shown), such that the coolant can absorb excess heat from the piston cylinders while in the cylinder jacket 104. The now heated coolant is then pumped through an Engine Coolant Temperature (ECT) sensor 105, which measures the temperature of the coolant.

From the ECT sensor 105, the coolant travels through a radiator, an in-cabin heater or a bypass 106 before returning to the pump 102 so that the cycle can begin again.

The temperature of the coolant as measured by the ECT sensor 105 is used to manage the behaviour of the first coolant system 101, so that the piston cylinders are kept at the correct temperature. For example, if the temperature measured by the ECT sensor 105 is low, then the coolant may be directed through the bypass so that the coolant retains heat and does not further cool the piston cylinders. In contrast, if the temperature measured by the ECT sensor 105 is high, then the coolant may be directed through the radiator so that the coolant loses heat and will subsequently further cool the piston cylinders.

This ECT sensor 105 provides a reliable temperature signal while the coolant is flowing. However, the ECT sensor 105 becomes unreliable when the coolant flow is stagnant.

There are situations in which halting or reducing the coolant flow is desirable. For example, at start up, the components of the engine are typically well below the preferred operating temperature, and it is desirable to heat up the cylinder heads as quickly as possible. Reducing coolant flow in these circumstances helps the engine to heat up more quickly, but at the cost of reducing the effectiveness of the ECT sensor 105.

FIG. 2 is a chart showing the temperature measured by the ECT sensor 105 over time, compared with the temperature of the Exhaust Valve Bridge (EVB), which is part of the casing around the cylinder head, as measured by a probe which is bored into the EVB. In the embodiment shown, the engine is started at a time t=0, and allowed to run for approximately 1200 seconds. The solid line shows the temperature measured by the ECT sensor 105, while the dotted line shows the cylinder head temperature as measured by the probe in the EVB. For the first ten minutes, the pump 102 is kept turned off until, at t=575, the pump is turned on. During this time, the cylinder head temperature is typically rising, with fluctuations according to engine activity in the vehicle. The ECT temperature, however, remains comparatively static, with only a slow rise due to conduction of heat through the engine and through the coolant, and due to convection currents in the coolant.

When the pump 102 is turned on there is a sharp decrease in the temperature of the cylinder heads, as fresh coolant is pumped through them, causing the temperature of the EVB to drop. This coincides with a sharp rise in the ECT temperature as hot coolant is moved away from the cylinder heads and towards the ECT sensor 105.

One alternative to the ECT sensor described above in relation to FIG. 1 is to use a temperature sensor located near the cylinder-head-end of the cylinder in an engine, as is shown in U.S. patent No. RE40,262 E. However, such a sensor is difficult to install, and difficult to reach during maintenance, due to its location. Such a sensor will also tend to give erratic readings, which fluctuate rapidly as the piston moves within the cylinder. In addition, boring into the engine block can weaken the structure surrounding the pistons, which may in turn reduce the operational lifetime of the engine.

Therefore it is desirable to provide a more reliable way to determine the temperature of a cylinder head.

### SUMMARY OF THE INVENTION

In accordance with an aspect of the present invention there is provided a method of determining the temperature of an inner section of a cylinder head in an internal combustion engine. The engine comprises: at least one piston cylinder, which cylinder is formed at least in part by the cylinder head; and at least one jacket, the jacket having a proximal wall and a distal wall. The proximal wall of the jacket is proximate to the piston cylinder and the distal wall of the jacket is distal to the piston cylinder. The method comprises: providing a temperature sensor on the distal wall of the jacket; receiving a first temperature measurement from the temperature sensor; and inferring the temperature of the inner section of the cylinder head from the first temperature measurement.

In this way, the invention provides a method for determining the temperature of an inner section of a cylinder head regardless of whether the coolant is flowing or not. If the jacket contains coolant then as the piston cylinder heats up, this heat is conducted into the coolant closest to the piston cylinder. Convection currents then cause the coolant to circulate so that all the coolant is heated and further conduction then raises the temperature of the distal wall of the jacket. This can then be detected by the temperature sensor. Heat is also conducted through the skin of the jacket itself. The skin of the jacket typically comprises a metal, such as aluminium.

The inner section of the cylinder head is at least partially contained within the coolant jacket. It may be that the inner section of the cylinder head comprises a sparkplug. It may be that the inner section of the cylinder head comprises at least one sensor. It may be that the inner section of the cylinder head comprises at least one duct for the flow of combustible fuel. Typically, the inner section of the cylinder comprises a wall of the cylinder.

The temperature recorded by the first temperature sensor is typically lower than the temperature of the cylinder head. However this temperature difference is predictable, and depends largely upon the shape and size of the engine components. As such, the relationship between the temperature recorded by the first temperature sensor and the temperature of the cylinder head can be determined in advance by experimentation, and the two can be related using a graph, table or equation as preferred.

Even in the event that the jacket is not filled with coolant, for example if the coolant system experiences a leak, the method described above will remain reliable, since heat may still be conducted through the skin of the jacket. Indeed, because of the lack of coolant the temperature at the sensor may rise more quickly.

The process of conduction and convection causes a lag between the temperature of the cylinder head and the temperature recorded by the first temperature sensor, so that in a typical embodiment changes in the temperature of the cylinder head cause a change in the temperature recorded by the first temperature sensor a short time later, for example, 2 to 3 seconds later. Advantageously, brief changes in the temperature of the cylinder head, those that appear and disappear in less than 2 seconds, are not typically reflected in the temperature recorded by the first temperature sensor. As such, transitory changes in temperature such as those created by movement of the piston and/or combustion within the cylinder, are not visible in the measurements taken by the first temperature sensor. Rather, the measurements taken by the first temperature sensor tend to reflect an average temperature of the cylinder head over several seconds.

It may be that the method further comprises: receiving a plurality of temperature measurements from the temperature sensor; and inferring changes in the temperature of the cylinder head over time from the plurality of temperature measurements.

It may be that the temperature sensor is arranged to measure the temperature of an outer surface of the jacket. It may be that the temperature sensor is located on an outer surface of the jacket. It may be that the temperature sensor is embedded in the jacket. Being isolated from the coolant can protect the temperature sensor from particulates which circulate in the coolant and build up on the sensor, reducing the sensor's reliability. Alternatively, it may be that the temperature sensor protrudes into the coolant within the jacket if this is preferred.

It may be that the method further comprises detecting an error in the engine based on temperature or change in temperature measured using the methods describe above. For example, if the coolant is leaking, this may cause a rapid rise in the temperature of the cylinder head which may be detected using the first temperature sensor as described above

An aspect of the invention provides an engine, the engine comprising:
a control unit;
at least one piston cylinder;
at least one jacket, the jacket having a proximal wall and a distal wall; and
a temperature sensor on the distal wall of the jacket,
the proximal wall of the jacket being proximate to the piston cylinder and the distal wall of the jacket being distal to the piston cylinder, wherein the control unit is arranged to carry out a method according to any of the methods described herein.

An aspect of the invention provides a method of controlling a coolant pump in an internal combustion engine. The engine comprises: the coolant pump; at least one piston cylinder; and at least one jacket, the jacket having a proximal wall and a distal wall and being suitable for containing coolant which is pumped by the pump. The proximal wall of the jacket is proximate to the piston cylinder and the distal wall of the jacket is distal to the piston cylinder. The method comprises: providing a temperature sensor on the distal wall of the jacket; receiving a first temperature measurement from the temperature sensor; and changing the behaviour of the pump according to the first temperature measurement.

In this way the pump can be operated or not according to the needs of the engine. For example, when the engine has just started up, the temperature of the cylinder head and hence the first temperature measurement may be very low. In response to the low first temperature measurement, the pump may be arranged to not pump coolant so that the cylinder head can heat up more quickly. Alternatively, once the engine has been operating for a while, the temperature of the cylinder head may be high, in which case a first temperature measurement will also be high. The pump may then be arranged to pump coolant in response to the high first temperature measurement, in order to prevent the cylinder head from overheating.

It may be that the method further comprises: receiving a second temperature measurement from the temperature sensor; and changing the behaviour of the pump according to a difference between the first and second temperature measurements.

It may be that the method further comprises: recording a plurality of temperature measurements received from the temperature sensor; and changing the behaviour of the pump according to a trend in the temperature measurements.

The method may further comprise: measuring a characteristic of the vehicle; and changing the behaviour of the pump according to at least the first temperature measurement and the characteristic of the vehicle. The measured characteristic may be indicative of work being done by the engine. The measured characteristic may be indicative of heat being generated by the engine. The measured characteristic may be a further temperature measurement, and it may be a measurement of the temperature of a further engine component. The measured characteristic may be a characteristic of the engine such as load. The measured characteristic may be the output torque of the engine or a measurement of engine speed. The measured characteristic may be a characteristic of the vehicle such as vehicle speed. More than one characteristic may be measured, and the method may comprise changing the behaviour of the pump according to at least the first temperature measurement and the more than one characteristic of the vehicle.

The method may further comprise: measuring the speed of the vehicle; and changing the behaviour of the pump according to at least the first temperature measurement and the speed of the vehicle.

The method may further comprise: measuring the load on the engine; and changing the behaviour of the pump according to at least the first temperature measurement and the load on the engine. The load on the engine is taken as a measure of the fuel being consumed by the engine.

It may be that the temperature sensor is arranged to measure the temperature of an outer surface of the jacket. It may be that the temperature sensor is located on an outer surface of the jacket. It may be that the temperature sensor is embedded in the jacket. Being isolated from the coolant can protect the temperature sensor from particulates which circulate in the coolant and build up on the sensor, reducing the sensor's reliability. Alternatively, it may be that the temperature sensor protrudes into the coolant within the jacket if this is preferred.

It may be that, for any of the methods describe above, the method comprises providing one temperature sensor for each piston in the engine. Alternatively, there may be one sensor for each group of pistons, or there may be one sensor for each coolant jacket. Typically, two temperature sensors are provided, one for each side of the engine. This may also be the case with an engine with a larger number of cylinders, say 6 or 8, where two ‘banks’ of cylinders are present. Alternatively such an engine with two banks of cylinders may be equipped with 4 sensors, one on each side of each bank.

An aspect of the invention provides an engine, the engine comprising:
a control unit;
a coolant pump;
at least one piston cylinder;
at least one jacket, the jacket having a proximal wall and a distal wall and being suitable for containing coolant which is pumped by the pump such that the coolant is contained between a proximal wall of the jacket and a distal wall of the jacket; and
a temperature sensor on the distal wall of the jacket,
the proximal wall of the jacket being proximate to the piston cylinder and the distal wall of the jacket being distal to the piston cylinder, the jacket being suitable for containing coolant which is pumped by the pump, wherein the control unit is arranged to carry out the method described elsewhere herein.

An aspect of the invention provides a vehicle which comprises an engine as described in other aspects of the invention.

### BRIEF DESCRIPTION OF THE DRAWINGS

Embodiments of the invention are further described hereinafter with reference to the accompanying drawings, in which:

FIG. 1 is a diagram of a first coolant system according to the prior art;

FIG. 2 is a graph showing the temperature in a first coolant system as measured by different sensors;

FIG. 3 is a diagram showing a piston cylinder with a coolant jacket and temperature sensor;

FIGS. 4 and 5 are illustrations of the piston cylinder as part of an engine block; and

FIG. 6 is a graph showing the temperature in a first coolant system as measured by different sensors.

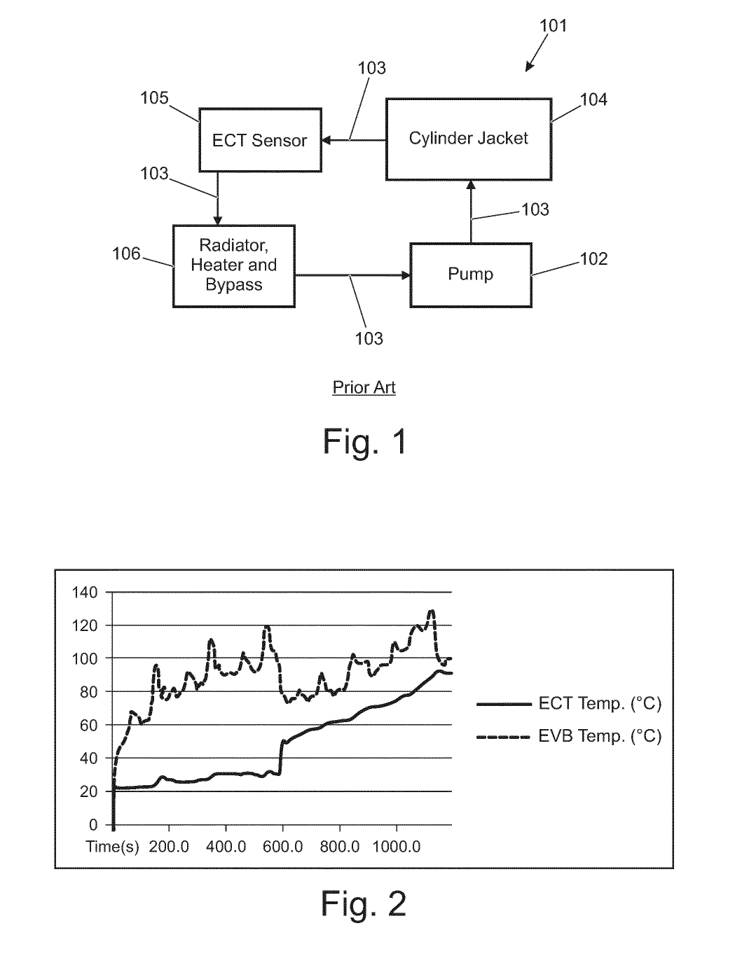

### DETAILED DESCRIPTION

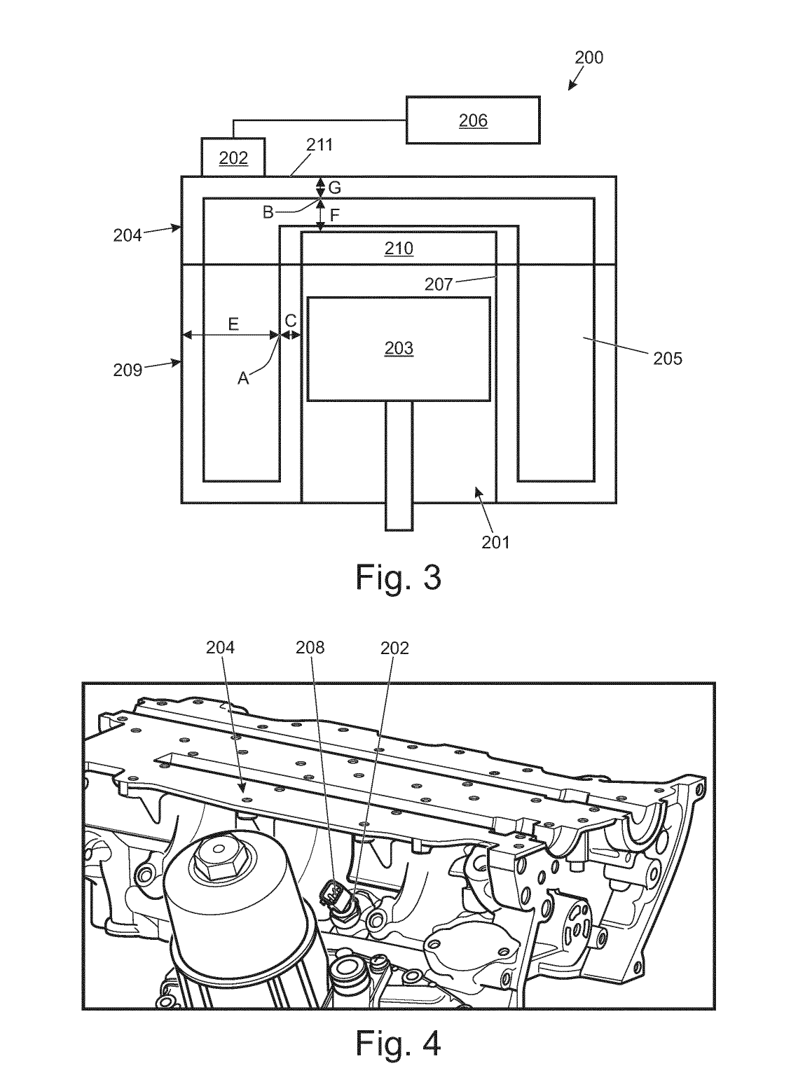

FIG. 3 is a block diagram showing an engine 200 comprising an engine block 209 and cylinder head 204 defining between them a piston cylinder 201. A Cylinder Head Temperature (CHT) sensor 202 according to the invention is connected to the cylinder head 204. The piston cylinder 201 contains a piston 203. The cylinder head 204 comprises an inner section 210 which contains the sparkplug (not shown) as well as valves and passages (not shown) for allowing fuel to enter the piston cylinder 201 and exhaust gasses to exit. Typically, the hottest part of engine 200 is the exhaust valve section of the inner section 210, since this section must contain and direct the hot gasses that result from combustion in the piston cylinder 201. The piston cylinder 201 is contained within the confines of a coolant jacket 205 defined by and contained within the cylinder head 204 and engine block 209. Coolant is allowed to flow through the jacket 205, cooling the piston cylinder 201, and in particular the cylinder head 204, as necessary.

The jacket 205 has a proximal wall 207 that is in direct contact with the cylinder 201 and a distal wall 211 that is in direct contact with the external environment. The external environment includes engine components, other than the CHT sensor, connected to, but not integrally part of, the cylinder head 204 or engine block 209. To determine whether a wall of the jacket 205 is proximal or distal, a straight line is drawn from a given point on the surface of the wall in contact with the coolant to the closest surface of the engine cylinder 201. In FIG. 3, this may be illustrated as first point A, where the line C represents the line just mentioned. If the line C passes through coolant, the wall is a distal wall at that point. Evidently, line C does not. However, line F from point B does. Thus the wall at point B is a distal wall.

If the line does not pass through coolant, then the wall at the first point may be a proximal wall or a distal wall. In that event, if the line from the first point to the closest point of the external environment passes through coolant, then the wall at that point is a proximal wall. In the case of point A, line E passes through coolant. Thus the wall at point A is a proximal wall.

If any point exists which does not satisfy only one of these two criteria, then the distance from that point to the closest surface of the engine cylinder is defined as the cylinder distance (C in the case of point A, and F in the case of point B). The distance from the same point to the closest point on the external environment is the environment distance (E in the case of point A, and G in the case of point B). If the environment distance is greater (E is greater than C), then the wall at that point is a proximal wall (wall at point A is thus a proximal wall). If the environment distance is less (G is less than F), then the wall at that point is a distal wall (wall at point B is thus a distal wall). There may be points on the internal surface of the jacket that are neither distal nor proximal with respect to the engine cylinder 201.

The CHT sensor 202 is located on the outside of a distal wall 211 of the coolant jacket 205, and is arranged so that the CHT sensor can measure the temperature of the outer skin of the coolant jacket 205. The shortest straight line from the cylinder 201 to the sensor 202 passes through coolant in the jacket 205. The CHT sensor 202 is connected to a control unit 206.

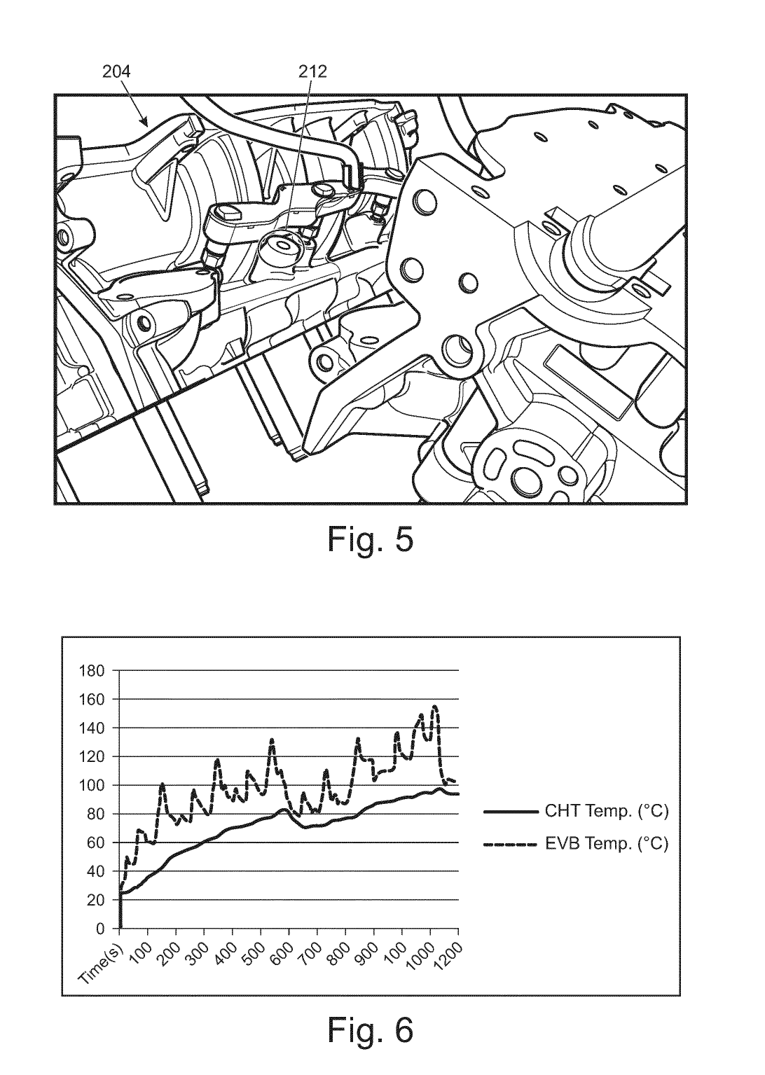

FIG. 4 is an illustration of what the CHT sensor 202 looks like in the context of the engine block. FIG. 5 shows the engine block from a different angle without the CHT sensor 202. The CHT sensor 202 is located on the outside of the engine cylinder head 204, which contains some of the coolant jacket 205. The CHT sensor 202 is mounted on a mounting point 212, which is visible in FIG. 5. The CHT sensor 202 comprises a plug 208 which is used to connect the CHT sensor 202 to the control unit 206. As can be seen in FIG. 4, the CHT sensor is located in an easily accessible location on the cylinder head 204, allowing for easy maintenance. The CHT sensor 202 may also be located some distance away from sources of heat other than the piston cylinder 201.

When the engine is in use, the piston 203 moves in the piston cylinder 201, which draws fuel into the piston cylinder 201 so that the fuel can be ignited. The combustion of the fuel then drives further movement of the piston 203. This process generates heat, tending to increase the temperature of the piston cylinder 201 and in particular the cylinder head 204. As the piston cylinder 201 heats up, this heat is absorbed by coolant in the coolant jacket 205. Convection of the heated coolant tends to create a current within the coolant in the coolant jacket 205, so that heat is then dispersed to the distal wall of the coolant jacket 205. The wall is then warmed in a way which is measured by the CHT sensor 202.

In addition, the cylinder head 204 and engine block 209 may be cast in aluminium, which conducts heat very efficiently. As such, some of the heat produced by the piston cylinder 201 is conducted by the aluminium which makes up the coolant jacket 205 to the distal wall of that jacket. This also provides a temperature change which is measured by the CHT sensor 202.

The piston cylinder 201 is fitted in an engine with a variable coolant pump which is arranged to pump coolant through the coolant jacket 205. The variable coolant pump can vary the rate of coolant flow it produces between zero and a maximum rate of coolant flow. The control unit 206 controls the variable pump and therefore the rate of coolant flow. The pump may not itself be variable, as such, but its output may be controlled using valves to deliver a variable flow to the jacket 205. Such an arrangement is included in the term “variable pump”, as well as a pump with an output which is itself intrinsically variable (for example, by speed variance or variance of blade or vane angle). The control unit is configured to adjust the rate of coolant flow according to the temperature measured by the CHT sensor.

When the vehicle is started, it is typically necessary to reduce the coolant flow to zero for a period of five to ten minutes while the engine heats up. This period of time varies depending upon the use of the engine and the ambient temperatures, as well as the inherent characteristics of the engine such as size and materials. During this period, the CHT sensor 202 provides periodic temperature measurements, typically one every few seconds, to the control unit 206. Once a first threshold temperature is reached by the distal wall of the coolant jacket 205, as measured by the CHT sensor 202, the pump is activated. The rate of coolant flow is then adjusted dynamically by the control unit 206 according to the temperature measured by the CHT sensor.

In practice, an increase in the temperature measured by the CHT sensor 202 typically causes the control unit 206 to increase the rate of coolant flow produced by the variable pump. However the rate of coolant flow is also affected by other factors in the engine. In particular, the control unit 206 accounts for the speed of the vehicle and the load on the engine when choosing a rate of coolant flow. Higher vehicle speeds are associated with greater cooling due to air flow, while higher engine loads are associated with more heat being produced by the combustion of greater amounts of fuel. The control unit 206 measures the speed of the vehicle by monitoring the wheel speed of the vehicle. The control unit 206 measures the load on the engine by recording the amount of fuel being supplied to the engine.

The control unit may be configured to also take account of other factors, such as the ambient temperature, which may be measured by sensors on the vehicle.

If the temperature recorded by the CHT sensor 202 is greater than a second threshold, then this indicates that there is a problem with the engine. Excessive temperatures may result if there is a problem with the coolant system or if the engine is under an excessive load. Either way, if the temperature recorded by the CHT sensor 202 is greater than that second threshold, then the control unit 206 will log an error. Logging an error may comprise recording the incident. Logging the error may also comprise providing the driver with an alarm such as a visible or audible signal.

If the temperature recorded by the CHT sensor 202 is greater than a third threshold, the third threshold being greater than or equal to the second threshold, then the control unit 206 will cause the engine to shut down.

The process of conduction and convection by which heat is conveyed from the cylinder 201 to the CHT sensor 202 takes a finite time to occur. Typically, the lag between the temperature of the inner section 210 of the cylinder head 204 and the temperature recorded by the CHT sensor 202 is on the order of 2 to 3 seconds. The process of conduction and convection also tends to even out the effects of momentary fluctuations in temperature. For example, in use the inner section 210 of the cylinder head 204 experiences a periodic increase in temperature, lasting only a fraction of a second and occurring several times a second, due to the movement of the piston head 203 and the combustion occurring within the cylinder 201. However, as these “spikes” in temperature propagate through the coolant jacket 205 they tend to smooth out as heat is conducted faster into colder areas. As such the spikes appear flattened or non-existent to the CHT sensor 202, which instead measures a temperature more representative of the average temperature of the inner section 210 of the cylinder head 204 over the course of several seconds, once allowance has been made for any decrease.

The CHT sensor 202 may advantageously be located on an upper surface of the coolant jacket 205. Upper surface in this case means a surface which is uppermost of the outer surfaces of the coolant jacket with respect to gravity when the vehicle is at rest with its wheels on a level surface. Therefore, when the vehicle has its wheels on a level surface, the convection currents in the coolant jacket 205 will tend to carry warm water upwards, towards the upper surfaces of the coolant jacket 211 and hence the CHT sensor 202. This tends to decrease the time delay between a change in the temperature of the inner section 210 of the cylinder head 204 and the corresponding change in the measurements of the CHT sensor 202. There will, of course, be direct pathways through the material of the cylinder head 204 to the sensor 202, which pathways may transmit heat more quickly than through convection or conduction through the void of the jacket 205, especially if coolant is missing from the jacket.

FIG. 6 is a chart showing the temperature measured by the CHT sensor 202 over time, in a vehicle according to the invention. The CHT sensor measurements are again compared with the temperature of the Exhaust Valve Bridge (EVB). Again, the engine is started at a time t=0, and allowed to run for approximately 1200 seconds. The pump is activated at t=575. The solid line shows the temperature measured by the CHT sensor 202, while the dotted line shows the cylinder head temperature as measured by the probe in the EVB. Until t=575, the cylinder head temperature is typically rising, with fluctuations according to engine activity in the vehicle. The CHT sensor data reflects this rise. Similarly at t=575, when the pump is turned on, there is a sharp decrease in the temperature of the EVB as fresh coolant is pumped through them. This decrease is also reflected by a decrease recorded by the CHT sensor 202.

As can be seen from the charts in FIGS. 2 and 6, the CHT sensor provides a much more accurate indication of the temperature of the EVB than an ECT sensor 105. This information can be used to more accurately control the vehicle, providing a more responsive and reliable and potentially economical vehicle for the user, while avoiding unnecessary wear on the engine components due to overheating.

The skilled practitioner will recognise that aspects and embodiments of the invention as described elsewhere herein will be workable, with suitable modifications if and as necessary, in the event that an engine is provided in which there are separate water jackets, at least one being for a head/cylinder head and another for the block or ‘short block’ of said engine.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

Aspects of the present invention are outlined in the following series of numbered paragraphs:

1. A method of determining the temperature of an inner section of a cylinder head in an internal combustion engine, wherein the engine comprises:
at least one piston cylinder, which cylinder is formed at least in part by the cylinder head; and
at least one jacket, the jacket having a proximal wall and a distal wall, the proximal wall of the jacket being proximate to the piston cylinder and the distal wall of the jacket being distal to the piston cylinder,
wherein the method comprises:
providing a temperature sensor on the distal wall of the jacket;
receiving a first temperature measurement from the temperature sensor; and
inferring the temperature of the inner section of the cylinder head from the first temperature measurement.

2. A method of determining the temperature of a cylinder head in an internal combustion engine according to numbered paragraph 1, the method further comprising:
receiving a plurality of temperature measurements from the temperature sensor; and
inferring changes in the temperature of the cylinder head over time from the plurality of temperature measurements.

3. A method of determining the temperature of a cylinder head in an internal combustion engine according to numbered paragraph 1 or numbered paragraph 2, in which the temperature sensor is arranged to measure the temperature of an outer surface of the jacket.

4. A method of controlling a coolant pump in an internal combustion engine, wherein the engine comprises:
the coolant pump;
at least one piston cylinder; and
at least one jacket, the jacket having a proximal wall and a distal wall and being suitable for containing coolant which is pumped by the pump,
the proximal wall of the jacket being proximate to the piston cylinder and the distal wall of the jacket being distal to the piston cylinder and the method comprising:
providing a temperature sensor on the distal wall of the jacket;
receiving a first temperature measurement from the temperature sensor; and
changing the behaviour of the pump according to the first temperature measurement.

5. A method of controlling a coolant pump in an internal combustion engine according to numbered paragraph 4, the method further comprising:
receiving a second temperature measurement from the temperature sensor; and
changing the behaviour of the pump according to a difference between the first and second temperature measurements.

6. A method of controlling a coolant pump in an internal combustion engine according to numbered paragraph 5, the method further comprising:
recording a plurality of temperature measurements received from the temperature sensor; and
changing the behaviour of the pump according to a trend in the temperature measurements.

7. A method of controlling a coolant pump in an internal combustion engine according to any of numbered paragraphs 4 to 6, the method further comprising:
measuring the speed of the vehicle; and
changing the behaviour of the pump according to at least the first temperature measurement and the speed of the vehicle.

8. A method of controlling a coolant pump in an internal combustion engine according to any of numbered paragraphs 4 to 7, the method further comprising:
measuring the load on the engine; and
changing the behaviour of the pump according to at least the first temperature measurement and the load on the engine.

9. A method of controlling a coolant pump in an internal combustion engine according to any of numbered paragraphs 4 to 8, in which the temperature sensor is arranged to measure the temperature of an outer surface of the jacket.

10. An engine, the engine comprising:
a control unit;
at least one piston cylinder;
at least one jacket, the jacket having a proximal wall and a distal wall and being suitable for containing coolant; and
a temperature sensor on the distal wall of the jacket,
the proximal wall of the jacket being proximate to the piston cylinder and the distal wall of the jacket being distal to the piston cylinder,
wherein the control unit is arranged to carry out the method according to any of numbered paragraphs 1 to 3.

11. An engine, the engine comprising:
a control unit;
a coolant pump;
at least one piston cylinder;
at least one jacket, the jacket having a proximal wall and a distal wall and being suitable for containing coolant which is pumped by the pump; and
a temperature sensor on the distal wall of the jacket,
the proximal wall of the jacket being proximate to the piston cylinder and the distal wall of the jacket being distal to the piston cylinder,
wherein the control unit is arranged to carry out the method according to any of numbered paragraphs 4 to 9.

12. A vehicle comprising an engine according to numbered paragraph 10 or numbered paragraph 11.

1-12. (canceled)

13. A method of controlling a coolant pump in an internal combustion engine of a vehicle, wherein the engine comprises:
the coolant pump;
at least one piston cylinder; and
at least one jacket, the jacket having a proximal wall and a distal wall and being suitable for containing coolant which is pumped by the pump,
the proximal wall of the jacket being proximate to the piston cylinder and the distal wall of the jacket being distal to the piston cylinder,
the method comprising:
providing a temperature sensor on or in the distal wall of the jacket such that at least a portion of the jacket lies between the temperature sensor and the piston cylinder;
measuring a speed of the vehicle;
receiving a first temperature measurement from the temperature sensor receiving a second temperature measurement from the temperature sensor; and
changing behavior of the pump according to a difference between the first and second temperature measurements.

14. (canceled)

15. A method of controlling a coolant pump in an internal combustion engine according to claim 14, comprising:
obtaining a plurality of temperature measurements received from the temperature sensor; and
changing the behavior of the pump according to a trend in the temperature measurements.

16. A method of controlling a coolant pump in an internal combustion engine according to claim 13, comprising:
measuring a load on the engine; and
changing the behavior of the pump according to at least the first temperature measurement and the load on the engine.

17. A method of controlling a coolant pump in an internal combustion engine according to claim 13, wherein the temperature sensor is arranged to measure the temperature of an outer surface of the jacket.

18. An engine, the engine comprising:
a control unit arranged to carry out the method according to claim 1;
a coolant pump;
at least one piston cylinder;
at least one jacket, the jacket having a proximal wall and a distal wall and being suitable for containing coolant which is pumped by the pump; and
a temperature sensor on or in the distal wall of the jacket such that at least a portion of the jacket lies between the temperature sensor and the cylinder,
the proximal wall of the jacket being proximate to the piston cylinder and the distal wall of the jacket being distal to the piston cylinder.

19. A vehicle comprising an engine according to claim 18.

20. A method of determining a temperature of an inner section of a cylinder head in an internal combustion engine, wherein the engine comprises:
at least one piston cylinder formed at least in part by the cylinder head; and
at least one jacket, the jacket having a proximal wall and a distal wall, the proximal wall of the jacket being proximate to the piston cylinder and the distal wall of the jacket being distal to the piston cylinder,
the method comprising:
providing a temperature sensor on or in the distal wall of the jacket such that at least a portion of the jacket lies between the temperature sensor and the piston cylinder;
receiving a first temperature measurement from the temperature sensor; and
inferring the temperature of the inner section of the cylinder head from the first temperature measurement.

21. A method of determining the temperature of a cylinder head in an internal combustion engine according to claim 20, comprising:
receiving a plurality of temperature measurements from the temperature sensor; and
inferring changes in the temperature of the cylinder head over time from the plurality of temperature measurements.

22. A method of determining the temperature of a cylinder head in an internal combustion engine according to claim 20, wherein the temperature sensor is arranged to measure the temperature of an outer surface of the jacket.

23. An engine, comprising:
a control unit arranged to carry out the method of claim 20;
at least one piston cylinder;
at least one jacket, the jacket having a proximal wall and a distal wall and being suitable for containing coolant; and
a temperature sensor on or in the distal wall of the jacket such that at least a portion of the jacket lies between the temperature sensor and the piston cylinder,
the proximal wall of the jacket being proximate to the piston cylinder and the distal wall of the jacket being distal to the piston cylinder,
wherein the control unit is arranged to carry out the method according to claim 19.

24. A vehicle comprising an engine according to claim 23.
